(19) United States
(12) Patent Application Publication
(10) Pub. No.: US 2022/0391876 A1
(43) Pub. Date: Dec. 8, 2022

(54) PAYMENT SYSTEM AND APPARATUS

(71) Applicant: Visa International Service Association, San Francisco, CA (US)

(72) Inventor: William Joseph Leddy, III, Lakeway, TX (US)

(21) Appl. No.: 17/773,653

(22) PCT Filed: Nov. 6, 2019
(86) PCT No.: PCT/US19/60001

§ 371 Date: May 2, 2022

(51) Int. Cl. G06Q 20/32; G06Q 20/14; G06Q 20/20; G06Q 20/40

(52) U.S. Cl. CPC G06Q 20/326; G06Q 20/3278; G06Q 20/145; G06Q 20/3274; G06Q 20/204; G06Q 20/40145; G06Q 2220/00

(57) ABSTRACT

A payment system apparatus configured to install with a merchant's non-payment equipment, comprising one or more payment tokens, a transceiver system and a housing, within which the transceiver system is installed, configured to install physically, electrically, wirelessly, or any combination thereof, with the merchant's non-payment equipment.

### CROSS-REFERENCE TO RELATED APPLICATION

This application is the United States national phase of International Application No. PCT/US2019/060001 filed Nov. 6, 2019, the entire disclosure of which is hereby incorporated by reference in its entirety.

### BACKGROUND

### 1. Technical Field

Provided are non-limiting embodiments or aspects of an apparatus used to create a seamless payment transaction when using a merchant's system that does not enable making a payment without the merchant's customer taking additional actions to conduct the transaction.

### 2. Technical Considerations

Not all merchant payments occur at a traditional cash register or through a merchant's web site. Payments may occur involving the use of other merchant payment equipment, for example, a point-of-sale system at a gas pump, garage kiosk, or parking meter. The use of this equipment may create friction for the customer because the customer must perform certain actions to make a payment, such as swiping a credit card, paying at a kiosk so that a ticket may be used to exit a parking lot, or typing information into a mobile application.

The use of merchant payment equipment and systems also introduces risk into a payment transaction. Skimmers may be installed on merchant payment equipment and used to steal payment account information when a card is swiped. The merchant payment equipment may also be used by fraudsters to test stolen cards. Furthermore, the merchant payment equipment may need to be upgraded to secure chip card payments, which can be expensive, as is system maintenance.

### SUMMARY

Accordingly, and generally, of the present disclosure provides improved apparatus, systems and methods embodying a payment system for use with a merchant's non-payment equipment. Preferably provided are apparatus, systems and methods for a payment system apparatus configured to install with a merchant's non-payment equipment comprising a transceiver system in a housing, within which the transceiver system is installed, configured to install electrically, physically, wirelessly, or any combination thereof, with the merchant's non-payment equipment.

According to non-limiting embodiments or aspects, provided is a payment system comprising a transceiver system in a housing and a payment token on a consumer platform that may be read by the transceiver system. Each payment token may be bound to the consumer's payment account and, optionally, to a payment application, for example, a bank's application, a merchant's application, a payment processor's application, a third-party's payment solution, or any combination thereof. Before making a payment, the transceiver system may capture the payment token and validate it with a payment processor, a bank, a merchant, a third-party's payment solution, or any combination thereof, to authorize the consumer's payment.

In some non-limiting embodiments or aspects, provided is a payment system apparatus that integrates with a merchant's non-payment equipment, comprising: at least one transceiver system arranged on or integrated with the merchant's non-payment equipment, the at least one transceiver system configured to read encoded account data stored on at least one payment token arranged on a surface of a structure that: opens or closes, raises and lowers, or any combination thereof; and an interface in communication with the at least one transceiver system, the interface configured to communicate the encoded account data to payment equipment associated with the at least one merchant, the payment equipment.

In some non-limiting embodiments or aspects, the payment system apparatus may comprise: at least one power system; at least one camera system; at least one RFID active receiver; at least one communication system; and a computer system programmed to receive, process and encrypt at least one payment token's payment account data, at least one communication signal comprising the payment token's payment account data, or any combination thereof, and communicate the result to at least one merchant's payment equipment which may comprise a point-of-sale, a merchant back-end server, a payment processor server, a bank server, or any combination thereof, and which may serve as an authentication server, an authorization server, or any combination thereof.

In some non-limiting embodiments or aspects, the payment system integrates with at least one merchant's non-payment equipment; reads payment account data from at the at least one payment token; and communicates the read payment account data to the at least one merchant's payment equipment located remotely from the merchant's non-payment equipment. In non-limiting embodiments or aspects, the at least one merchant's payment equipment comprises a server, a payment processor server, a bank server, or any combination thereof. In non-limiting embodiments or aspects, the at least one non-payment apparatus comprises a gas pump handle or nozzle.

In non-limiting embodiments or aspects, the at least one payment token attaches to a surface of a structure that opens and closes, or raises and lowers, or any combination thereof. In some non-limiting embodiments or aspects, the at least one power system comprises a solar panel powering a battery. In some non-limiting embodiments or aspects, the at least one power system comprises a battery. In some non-limiting embodiments or aspects, the at least one camera system comprises a camera, a lighting source, or any combination thereof. In some non-limiting embodiments or aspects, the at least one communication system comprises a near-field communication system, a Wi-Fi system, a Bluetooth system, or any combination thereof. In some non-limiting embodiments or aspects, the computer system comprises a single-board computer, a multi-chip processor, a programmed array, a neural net processor, or any combination thereof. In some non-limiting embodiments or aspects, the at least one payment token comprises a QR code, a bar code, or any combination thereof. In some non-limiting embodiments or aspects, the at least one communication signal comprises a RFID signal, Wi-Fi signal, a Bluetooth signal, or any combination thereof. In some non-limiting embodiments or aspects, the at least one payment token comprises an RFID tag. In some non-limiting embodiments or aspects, the at least one payment token comprises a QR code or a bar code. In some non-limiting embodiments or aspects, the at least one payment token comprises an embossed QR image or an etched QR image. In some non-limiting embodiments or aspects, the at least one payment token comprises an embossed bar code image or an etched bar code image. In some non-limiting embodiments or aspects, the at least one payment token is associated with payment account data comprising an arbitrary long alphanumeric value, a credit card number, a debit card number, a biometric, a BIN number, user name, or any combination thereof.

In some non-limiting embodiments or aspects, provided is a payment system method comprising at least one payment system apparatus: acquiring a payment token; authenticating the at least on payment token in at least one payment application; entering account information for at least one account encoded on the at least one payment token in the at least one payment application; scanning or manually entering, or any combination thereof, the at least one payment token in the at least one payment application, in response to which the application links the at least one payment token with the account information; and registering and communicating the linked account information to at least one merchant payment equipment.

In some non-limiting embodiments or aspects, the at least one payment token comprises a QR code, a bar code, a RFID tag, or any combination thereof. In non-limiting embodiments or aspects, the at least one payment token comprises at least one of the following: a QR code, a bar code, or any combination thereof.

According to non-limiting embodiments or aspects, provided is a payment system method, wherein the at least one payment system apparatus acquires a payment token; processes at least one account information for at least one account; and communicates the account information to at least payment equipment of at least one merchant.

In some non-limiting embodiments or aspects, provided is a computer program product for capturing at least one payment token's payment account data from a payment token linked to at least one payment account comprising at least one non-transitory computer-readable medium including one or more instructions that, when executed by at least one computer system, cause the at least one computer system to: encrypt payment account data of a payment token that links to a payment account and communicate the payment token's encrypted payment information to the merchant's payment equipment comprising a server, a payment processor server, a bank server, or any combination thereof, any of which may comprise an authentication server, an authorization server, or any combination thereof, in response to which, it receives an authorization response from the authorization server and enables a merchant's non-payment equipment to operate or to receive payment, or any combination thereof, when the payment is authorized.

In some non-limiting embodiments or aspects, the at least one payment token comprises a QR Code, a bar code, or a RFID tag, or any combination thereof.

In some non-limiting embodiments or aspects, provided is a payment system configured to integrate with a merchant's non-payment equipment, comprising: at least one payment token comprising encoded information linked to account data for a user, the at least one payment token arranged on a vehicle associated with the user; a transceiver system arranged on or integrated with the merchant's non-payment equipment, the transceiver system configured to read at least one payment token, to process the encoded account data from the at least one payment token, and to communicate the encoded account information to the payment equipment of at least one of a merchant.

In some non-limiting embodiments or aspects, the merchant payment equipment may comprise a point-of-sale, a merchant back-end server, a payment processor server, a bank server, or any combination thereof, and which may serve as an authentication server, an authorization server, or any combination thereof. In some non-limiting embodiments or aspects In some non-limiting embodiments or aspects, the at least one payment token comprises at least one of the following: a physical sticker comprising printed indicia representing the at least one payment token, a radio frequency transponder, a display device configured to display printed indicia representing the at least one payment token, a transmitter configured to transmit signals representing the at least one payment token, or any combination thereof. In some non-limiting embodiments or aspects, the at least one payment token includes printed indicia representing the at least one payment token, the printed indicia comprising a barcode.

In some non-limiting embodiments or aspects, provided is a method for processing payments with a merchant's non-payment equipment, comprising: scanning, with a transceiver system arranged on or integrated with the non-payment equipment, at least one payment token arranged on a vehicle associated with a user, the at least one payment token, the at least one payment token comprising encoded information linked to account data for the user; communicating, with an interface coupled to the transceiver system, the encoded information to at least one of a merchant point-of-sale system and a transaction processing system; determining, with the transaction processing system, an account identifier corresponding to the encoded information; and processing, with the transaction processing system, a payment transaction based on the account identifier.

In some non-limiting embodiments or aspects, the non-payment equipment comprises a gas pump handle or nozzle.

Other non-limiting embodiments or aspects of the present disclosure will be set forth in the following numbered clauses:

Clause 1: A payment system apparatus that integrates with a merchant's non-payment equipment, comprising: at least one transceiver system arranged on or integrated with the merchant's non-payment equipment, the at least one transceiver system configured to read encoded account data stored on at least one payment token arranged on a surface of a structure that: opens or closes, raises and lowers, or any combination thereof; and an interface in communication with the at least one transceiver system, the interface configured to communicate the encoded account data to payment equipment associated with the at least one merchant, the payment equipment.

Clause 2: The payment system apparatus of clause 1, further comprising: at least one power system; at least one camera system; at least one RFID active receiver; at least one communication system; and a computer system programmed to receive, process and encrypt at least one payment token's payment account data, at least one communication signal comprising the payment token's payment account data, or any combination thereof, and communicate the result to at least one merchant's payment equipment which may comprise a point-of-sale, a merchant back-end server, a payment processor server, a bank server, or any combination thereof, and which may serve as an authentication server, an authorization server, or any combination thereof.

Clause 3: The payment system apparatus of clauses 1 or 2, wherein the at least one payment system apparatus: integrates with at least one merchant's non-payment equipment; reads payment account data from at the at least one payment token; and communicates the read payment account data to the at least one merchant's payment equipment located remotely from the merchant's non-payment equipment.

Clause 4: The payment system apparatus of any of clauses 1-3, wherein the at least one merchant's payment equipment comprises a server, a payment processor server, a bank server, or any combination thereof.

Clause 5: The payment system apparatus of any of clauses 1-4, wherein the at least one non-payment apparatus comprises a gas pump handle or nozzle.

Clause 6: The payment system apparatus of any of clauses 1-5, wherein the at least one payment token attaches to a surface of a structure that opens and closes, or raises and lowers, or any combination thereof.

Clause 7: The payment system apparatus of any of clauses 1-6, wherein the at least one power system comprises a solar panel powering a battery.

Clause 8: The payment system apparatus of any of clauses 1-7, wherein the at least one power system comprises a battery.

Clause 9: The payment system apparatus of any of clauses 1-8, wherein the at least one camera system comprises a camera, a lighting source, or any combination thereof.

Clause 10: The payment system apparatus of any of clauses 1-9, wherein the at least one communication system comprises a near-field communication system, a Wi-Fi system, a Bluetooth system, or any combination thereof.

Clause 11: The payment system apparatus of any of clauses 1-10, wherein the computer system comprises a single-board computer, a multi-chip processor, a programmed array, a neural net processor, or any combination thereof.

Clause 12: The payment system apparatus of any of clauses 1-11, wherein the at least one payment token comprises a QR code, a bar code, or any combination thereof.

Clause 13: The payment system apparatus of any of clauses 1-12, wherein the at least one communication signal comprises a RFID signal, Wi-Fi® signal, a Bluetooth signal, or any combination thereof.

Clause 14: The payment system apparatus of any of clauses 1-13, wherein the at least one payment token comprises an RFID tag.

Clause 15: The payment system apparatus of any of clauses 1-14, wherein the at least one payment token comprises a QR code or a bar code.

Clause 16: The payment system apparatus of any of clauses 1-15, wherein the at least one payment token comprises an embossed QR image or an etched QR image.

Clause 17: The payment system apparatus of any of clauses 1-16, wherein the at least one payment token comprises an embossed bar code image or an etched bar code image.

Clause 18: The payment system apparatus of any of clauses 1-17, wherein the at least one payment token is associated with payment account data comprising an arbitrary long alphanumeric value, a credit card number, a debit card number, a biometric, a BIN number, user name, or any combination thereof.

Clause 19: A payment system method comprising at least one payment system apparatus: acquiring a payment token; authenticating the at least on payment token in at least one payment application; entering account information for at least one account encoded on the at least one payment token in the at least one payment application; scanning or manually entering, or any combination thereof, the at least one payment token in the at least one payment application, in response to which the application links the at least one payment token with the account information; and registering and communicating the linked account information to at least one merchant payment equipment.

Clause 20: The payment system method of clause 19, wherein the at least one payment token comprises a QR code, a bar code, a RFID tag, or any combination thereof.

Clause 21: The payment system method of clauses 19 or 20, wherein the at least one payment token comprises at least one of the following: QR code, a bar code, or any combination thereof.

Clause 22: The payment system method of any of clauses 19-21, wherein the at least one payment system apparatus acquires a payment token; processes at least one account information for at least one account; and communicates the account information to at least one payment equipment of at least one merchant.

Clause 23: A computer program product for capturing at least one payment token's payment account data from a payment token linked to at least one payment account comprising at least one non-transitory computer-readable medium including one or more instructions that, when executed by at least one computer system, cause the at least one computer system to: encrypt payment account data of a payment token that links to a payment account and communicate the payment token's encrypted payment information to the merchant's payment equipment comprising a server, a payment processor server, a bank server, or any combination thereof, any of which may comprise an authentication server, an authorization server, or any combination thereof, in response to which, it receives an authorization response from the authorization server and enables a merchant's non-payment equipment to operate or to receive payment, or any combination thereof, when the payment is authorized.

Clause 24: The computer program product of clause 23, wherein the at least one payment token comprises a QR Code, a bar code, or a RFID tag, or any combination thereof.

Clause 25: A payment system configured to integrate with a merchant's non-payment equipment, comprising: at least one payment token comprising at least one payment token, the at least one payment token comprising encoded information linked to account data for a user, the at least one payment token arranged on a vehicle associated with the user; a transceiver system arranged on or integrated with the merchant's non-payment equipment, the transceiver system configured to read at least one payment token, to process the encoded account data from the at least one payment token and to communicate the encoded account information to the payment equipment of at least one of a merchant.

Clause 26: The payment system of clause 25, wherein the merchant payment equipment comprises a point-of-sale, a merchant back-end server, a payment processor server, a bank server, or any combination thereof, and which may serve as an authentication server, an authorization server, or any combination thereof.

Clause 27: The payment system of clauses 25 or 26, wherein the at least one payment token comprises at least one of the following: a physical sticker comprising printed indicia representing the at least one payment token, a radio frequency transponder, a display device configured to display printed indicia representing the at least one payment token, a transmitter configured to transmit signals representing the at least one payment token, or any combination thereof.

Clause 28: The payment system of any of clauses 25-27, wherein the at least one payment token includes printed indicia representing the at least one payment token, the printed indicia comprising a barcode.

Clause 29: A method for processing payments with a merchant's non-payment equipment, comprising: scanning, with a transceiver system arranged on or integrated with the non-payment equipment, at least one payment token arranged on a vehicle associated with a user, the at least one payment token, the at least one payment token comprising encoded information linked to account data for the user; communicating, with an interface coupled to the transceiver system, the encoded information to at least one of a merchant point-of-sale system and a transaction processing system; determining, with the transaction processing system, an account identifier corresponding to the encoded information; and processing, with the transaction processing system, a payment transaction based on the account identifier.

Clause 30: The method of clause 29, wherein the non-payment equipment comprises a gas pump handle or nozzle.

### BRIEF DESCRIPTION OF THE DRAWINGS

Additional advantages and details of the payment system are explained in greater detail below with reference to exemplary embodiments or aspects that are illustrated in the following drawings. In the drawings:

FIG. 1 is a schematic view of non-limiting embodiments or aspects of a payment system according to the present disclosure;

FIGS. 2a and 2b are perspective views of non-limiting embodiments or aspects of an installed payment system according to the present disclosure;

FIG. 3 is a schematic view of non-limiting embodiments or aspects of a payment system according to the present disclosure;

FIG. 4 is a schematic view of non-limiting embodiments or aspects of a payment system and housing according to the present disclosure;

FIG. 5 is a schematic view of non-limiting embodiments or aspects of a payment system in operation according to the present disclosure;

FIG. 6 is a schematic view of non-limiting embodiments or aspects of a payment system in operation according to the present disclosure;

FIG. 7 is a schematic view of non-limiting embodiments or aspects of a payment system in operation according to the present disclosure;

FIG. 8 is a process flow of non-limiting embodiments or aspects of the process to register a payment account in a payment system according to the present disclosure;

FIG. 9 is a process flow of non-limiting embodiments or aspects of the process to register a payment account in a payment system according to the present disclosure;

FIG. 10 is a process flow of non-limiting embodiments or aspects of the process to make a payment in a payment system according to the present disclosure;

FIG. 11 is a process flow of non-limiting embodiments or aspects of the process to make a payment in a payment system according to the present disclosure;

FIG. 12 is a process flow of non-limiting embodiments or aspects of the process to make a payment in a payment system according to the present disclosure;

FIG. 13 is a process flow of non-limiting embodiments or aspects of the process to make a payment in a payment system according to the present disclosure;

### DETAILED DESCRIPTION

It is to be understood that the payment system may assume various alternative variations and step sequences, except where expressly specified to the contrary. It is also to be understood that devices and processes illustrated in the attached drawings, and described in the following specification, are simply exemplary embodiments or aspects of the payment system. Hence, specific dimensions and other physical characteristics related to the embodiments or aspects disclosed herein are not to be considered as limiting.

As used herein, the term “non-payment equipment” refers to a component of a merchant system that is not designed, built, or programmed to directly receive and process payments, even if other aspects of the merchant system do include merchant payment equipment, such as a point-of-sale device, a payment application, or an interface through which a payment may be made. The description and figures which follow use a gas pump as an exemplary embodiment of merchant non-payment equipment. Other examples may include, but would not be limited to, a parking meter or a parking lot entrance and exit gate.

As used herein, the term “payment token” may refer to a tag, sticker, or image of a tag or sticker that may store in memory, embed, or map to payment account data, wherein the tag or sticker may be an RFID tag comprising an integrated circuit and antenna, a barcode (e.g., a one-dimensional barcode or a two-dimensional barcode, such as a QR code, Bluetooth® Low Energy beacon, or any combination thereof, which may be affixed to or printed on one side of a material substrate that has an adhesive material on the other side of the material substrate, or wherein the image of a barcode may be an embossed or etched image of the barcode on a metal, plastic, or other solid substrate.

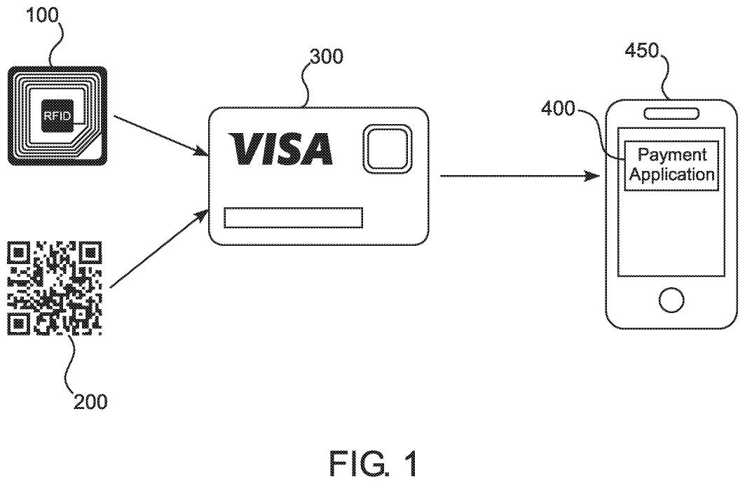

According to non-limiting embodiments or aspects, FIG. 1 depicts payment tokens in the form of an RFID tag 100 and a QR code 200 that may be bound to a payment account 300 within at least one payment application 400 hosted on at least one device 450, in this case a mobile phone of an account holder to which the payment account 300 belongs . Other such examples of the device 450 may include tablets, laptop or desktop computers, or voice recognition appliances such as Apple's iHome®, Amazon's Alexa®, or Google's Home systems. Payment application 400 may be a bank's payment application, a payment processor's payment application (such as Visa's®, MasterCard's®, American Express'®, Discover Card's®, or China Union Pay's®), a merchant's payment application (such as Alipay's®), a third-party payment solution (such as Apple Pay®, Google Pay®, or Samsung Pay®), or any combination thereof.

RFID tag 100 may store a unique value that is of sufficient length and/or complexity to prevent or make improbable brute force guessing attacks. Similarly, a QR code 200 may encode the same or an equivalent unique value. The unique value may be an alphanumeric that is not an account number or any other information associated with a payment account, including, but not limited to, a password, an arbitrary alphanumeric used by a payment system to represent the account, or a PIN. Hereafter, the long value or other information will be referred to by the term “payment account data.”

To bind RFID tag 100 or QR code 200 with a payment account 300, the account holder may, if using a properly equipped device, use the device to read RFID tag 100 or scan QR code 200 into a payment application hosted on the device.

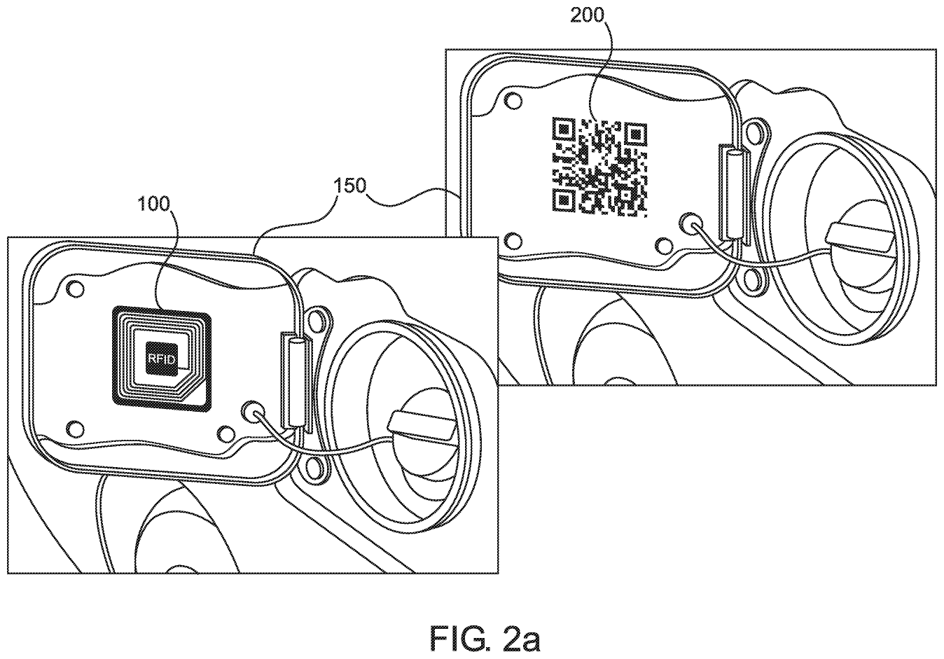

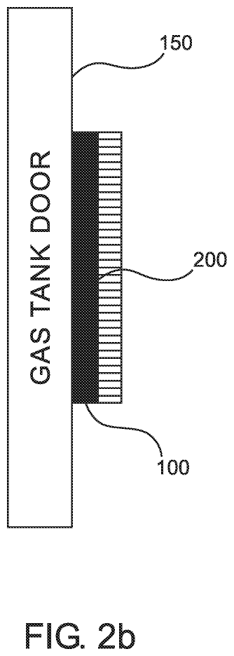

According to non-limiting embodiments or aspects, FIG. 2a illustrates an installation of RFID tag 100 and QR code 200 on the inside of a car's gas tank door 150 wherein each may be installed individually. In non-limiting embodiments or aspects, FIG. 2b illustrates an installation in which RFID tag 100 and QR code 200 are installed together, with QR code 200 mounted on top of, or overlaying RFID tag 100, which, in turn, is mounted on an interior side of gas tank door 150. In another representative configuration they may be mounted side-by-side. For enhanced security purposes, the gas tank door 150 may be locked so that it may may not be read without key access to door. Alternate means to preserve the payment token(s) security may be to affix them to a car door's frame, which may be similarly locked.

When the payment tokens may be used as an ancillary device with other payment equipment, such as a parking meter or garage entry or exit gate, security enhancements may include enclosing the payment token(s) in a container that has a door on a front surface and adheres to the back of an interior rear-view mirror of a car on its back surface, whereupon the payment tokens are not readable from the outside when the car is locked and the container's door is closed, but are readable when someone in the car opens the container's door to be read by a transceiver system 500 that is described below.

The payment token may also be used in non-automotive or mobile vehicle applications, for example, in a closable wallet or cover of a tablet that may be opened to display an affixed payment token for use at a ticket window, at a retail point-of-sale, with a stadium vendor, with home TVs or appliances, any of which is equiped with a transceiver system of the type described herein that may communicate with a merchant's backend payment.

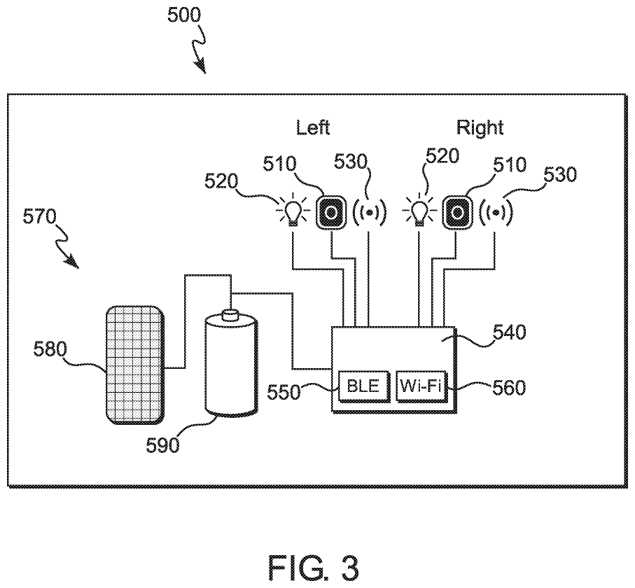

According to non-limiting embodiments or aspects, FIG. 3 illustrates commercially available components that may comprise a transceiver system 500. One component may be at least one active receiver 530, often referred to as an interrogator that reads RFID tag 100. To do so, active receiver 530 may send interrogator signals to RFID tag 100 and may receive authentication replies and its stored payment account data, in response to which transceiver system 500 may communicate the received payment account data to a single-board computer 540 for further processing.

Transceiver system 500 may incorporate at least one camera system 510, often referred to as a scanner, which may read QR code 200 and communicate the QR code's payment account data to the single-board computer 540 for further processing. Camera 510 may incorporate or interact with at least one illumination system 520, which may comprise an illumination sensor, a daylight timer—which may communicate with a daylight application (not shown) that may either be on the single-board computer 540 or on a remotely accessed server (not shown)—or an illumination source or flash that may be used to illuminate QR code 200 in dim lighting as assessed by the illumination system 520. Camera systems with one or more of the capabilities described for camera system 510 may be found in smart phones today, such as iPhone X, Pixel 2, or Galaxy Note 8.

To ensure that the RFID tag 100's authentication replies and stored values are not compromised, the active receiver 530 adheres to standard specifications addressing privacy and security issues such as ISO/IEC 18000 and ISO/IEC 29167 for use of on-chip cryptography methods for intractability, tag and receiver authentication, and over-the-air privacy; ISO/IEC 20248 for an RFID digital signature data structure for RFID and barcodes providing data, source and read method authenticity; and ISO/IEC JTC 1/SC 31 addressing automatic identification and data capture techniques.

Transceiver system 500 may use at least one single-board computer 540, (for example, an Arduino single-board microcontroller) to control an active receiver 530 and a camera system 510. Additionally, the single-board computer 540 may further process and communicate the payment account data received from these systems. Such further processing may include combining the payment account data with a nonce and encrypting it before it communicates the encrypted information to a merchant's server for continued payment authentication and authorization processing.

The single-board computer 540 may communicate to a merchant's server using a Bluetooth® low energy (BLE) device 550, a Wi-Fi® device 560, or any combination thereof. Such devices may be available from companies such as Broadcom and Qualcomm.

The communications sent using a BLE device 550 or a Wi-Fi® device 560, or any combination thereof, may be sent to a merchant's server, in response to which the encrypted payment account data may be further communicated by the merchant's server to a payment processor or an issuer, or any combination thereof, for associating the communicated encrypted information with the payment account to which it is bound for authorization and continued payment processing.

Finally, transceiver system 500 may incorporate at least one power system 570, which may in turn be comprised of a solar panel 580 coupled to a battery 590, or simply by a battery 590 alone. If the power system 570 incorporates the solar panel 580, then the solar panel 580 charges the battery 590, which is a rechargeable long-term storage battery. If the power system 570 comprises a battery alone, then the battery 590 may be a stand-alone long-life battery which may or may not be rechargeable. Batteries with the capabilities described herein include those that are and will be used with smartphones and internet-of-thing devices.

If the power system 570 uses the solar panel 580, then the solar panel 580 may comprise such technology as organic photovoltaic technology or crystalline solar technology, one that may enable the solar panel 570 to mold to the surfaces of a housing 900 described below.

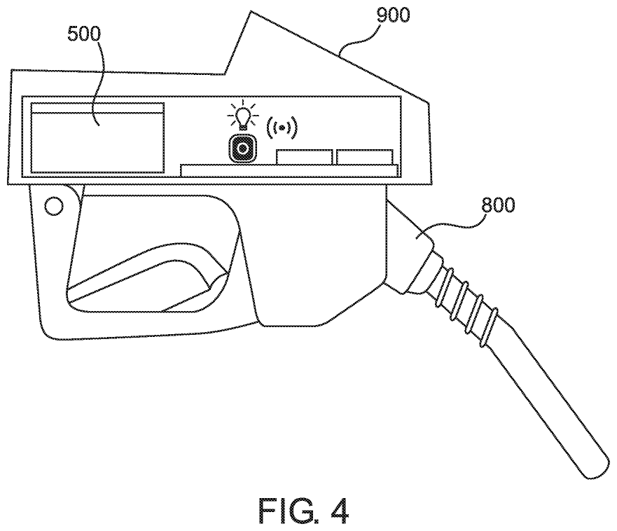

According to non-limiting embodiments or aspects, FIG. 4 illustrates a housing 900 into which the transceiver system 500 may be installed on a merchant's non-payment equipment, in this embodiment on a gas pump 800 nozzle for a gas pump application. Transceiver system 500, in such a use case, may be comprised of one power system 570, one single-board computer 540, two active receivers 530, and two camera systems 510. One of the two active receivers 530 and one of the two camera systems 510 may be positioned on the right side of the gas pump nozzle 800, with the second active receiver 530 and second camera system 510 positioned on the left side of the gas pump nozzle. Such a configuration enables the transceiver system 500 to read a RFID tag 100 and/or a QR 200 code that may be on a gas tank door 150 that may be located on either the right-side or the left-side of a vehicle.

In additional possible applications, as when the transceiver system 500 may be used with a parking meter, a garage entry and/or exit system, a closed wallet, or tablet application, only one active receiver 530 and one camera system 510 may suffice. In such applications, RFID tag 100 or QR code 200 may located on the back of a rear-view mirror, on a license plate in a wallet or the cover of a tablet that directly faces the transceiver system 500.

Further to the non-limiting embodiment or aspect depicted in FIG. 4, the housing 900 mechanically interfaces with a gas pump, since it is not assumed that the gas pump nozzle is configured to power the transceiver system 500. If the gas pump nozzle 800 may power transceiver system 500, then its mechanical interface may be supplemented with an electrical interface that powers the transceiver system 500. If this may be the case, then power system 570 may be eliminated or used as a back-up power system in the event that the electrical interface with gas pump nozzle 800 fails.

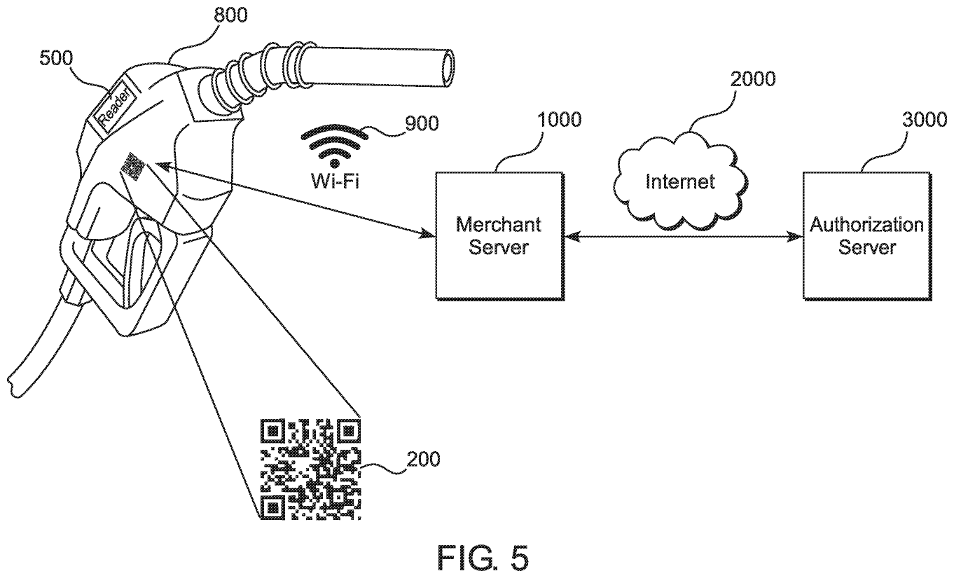

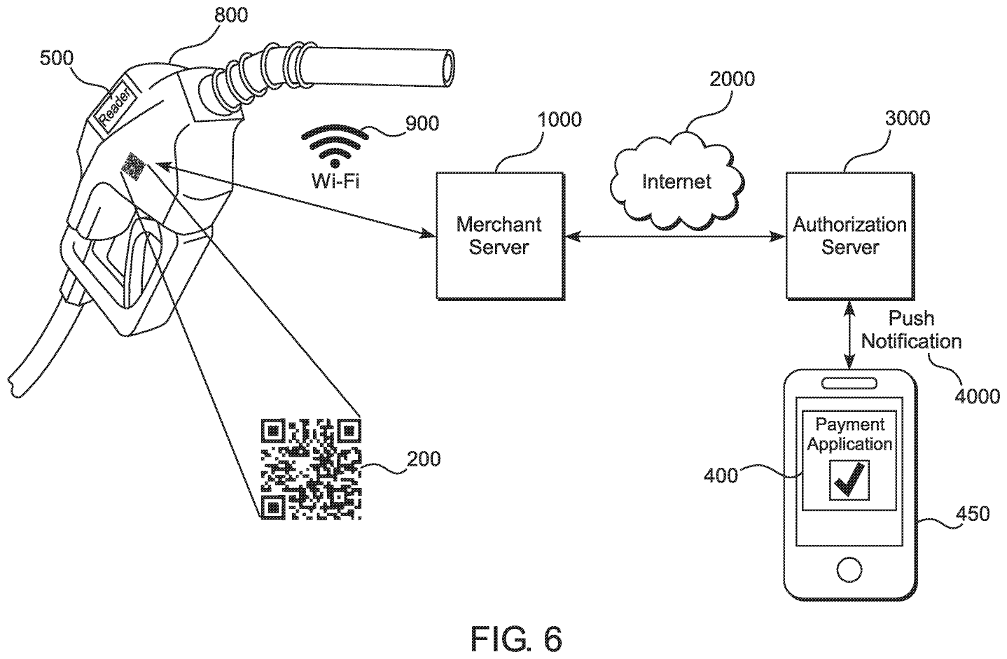

According to non-limiting embodiments or aspects, FIG. 5 and FIG. 6 illustrate how the transceiver system 500 may operate with a merchant and a bank to authorize a payment transaction. FIG. 5 depicts the transceiver system 500 capturing a QR code 100 and shows its processed encrypted payment account data being communicated by a Wi-Fi® signal 900 to a merchant's server 1000, which, in turn, transmits the processed information over an Internet channel 2000 to an authorization server 3000, which may be hosted by an issuer. If the authorization server authorizes the payment, the payment transaction may be concluded.

FIG. 6 presents a similar flow of information with one addition. The addition comprises an additional communication to a device of the account holder that may be used to make the payment. In FIG. 6, the additional communication may comprise a wireless push notification 4000 from the authorization server 3000 to the payment application 400 on the device 450 (a mobile phone for the purposes of this and the following illustrations) indicating a status of the payment transaction, e.g., that it may or may not have been successfully concluded.

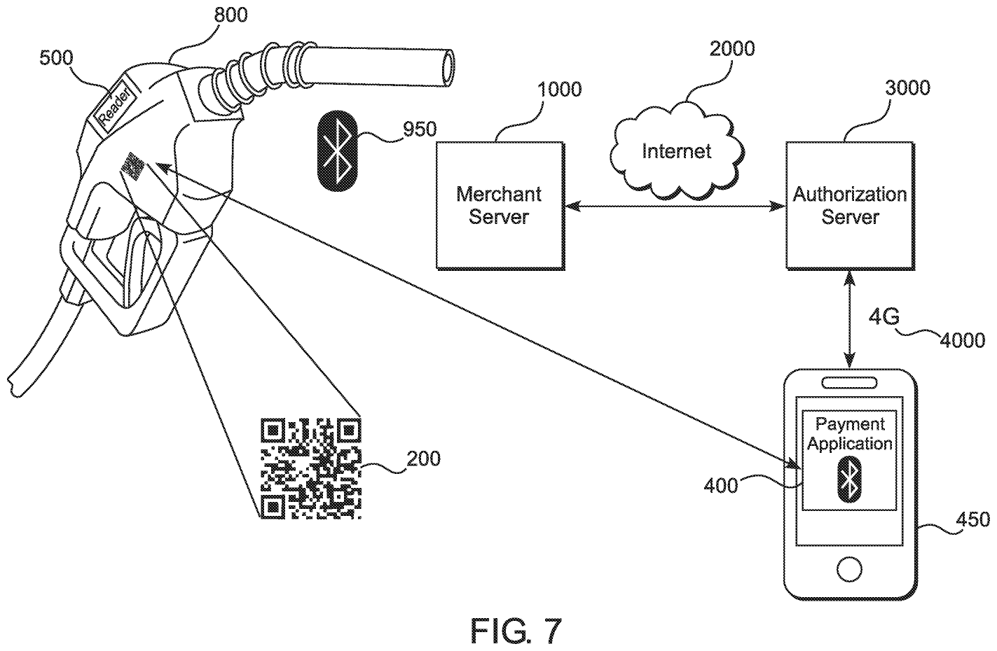

According to non-limiting embodiments or aspects, FIG. 7 characterizes an alternate payment communication flow whereby the auxliary payment system may be used to enable payment transaction processing. Consider two representative use cases. In a first use case, the QR payment account data may be processed by transceiver system 500 and communicated via BLE signal 950 to the payment application 400 on the device 450, which in turn communicates the processed information to authorization server 3000 using a telecommunication signal, shown in FIG. 7 as a 4G signal 4000.

In a second illustrative use case illustrated by FIG. 7, the transceiver system 500's camera system may capture the QR code 200's payment account data and transceiver system 500's BLE device may detect the signal 950 communicated by the account holder's device 450, whereupon it may activate the payment application 400 through a transmission of a BLE signal 950. In response to its activation, the payment application 400 may receive the encrypted QR code 200's payment account data and then send it along with device identity, geolocation information, other user related information stored with the payment application, or any combination thereof, to authorization server 3000 using the 4G signal 6000, in response to which the authorization server 3000 may send an authorization message to the merchant server 1000. The authorization message may be a payment transaction pre-approval message, a payment transaction approval message or a payment transaction decline message.

While FIGS. 5-7 are illustrated using a QR code, an RFID tag alone or a combination of a QR code and RFID tag may be used instead. Further, when the transceiver system 500 captures the payment token(s) payment account data, wherein it may be combined with a nonce and encrypted before it may be communicated to a merchant's server, depending on a policy, the merchant's server may authorize the payment transaction locally, or pass the processed information to a payment processor's or a bank's authorization server for authentication, authorization, or any combination thereof. Further, depending on a policy, the payment transaction may be approved immediately and locally by using two-factor authentication which may be comprised of a payment token(s) payment account data, device 540 information, payment application 400 stored information, or any combination thereof.

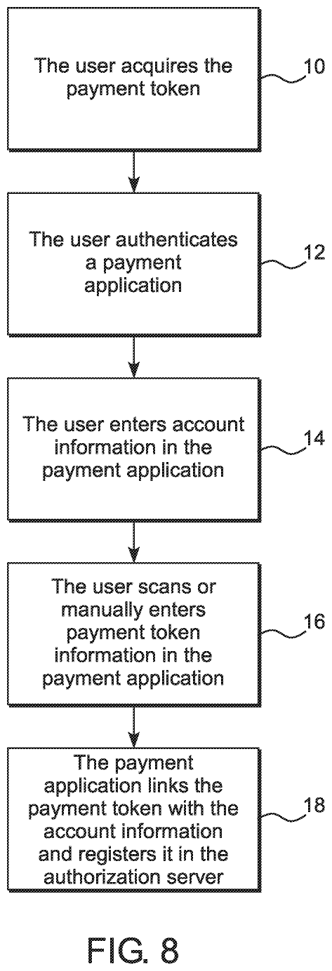

According to non-limiting embodiments or aspects, FIG. 8 characterizes steps an account holder may use to bind a payment account to a payment token. In step 10, the account holder may acquire a payment token, which he or she may then authenticate in a payment application in step 12. The account holder next may enter his or her account information into the payment application in step 14, after which he or she may scan or manually enter payment token information into the payment application. Based on data entered, in a final step, step 18, the payment application may bind the payment token information with the account information and register it in an authorization server.

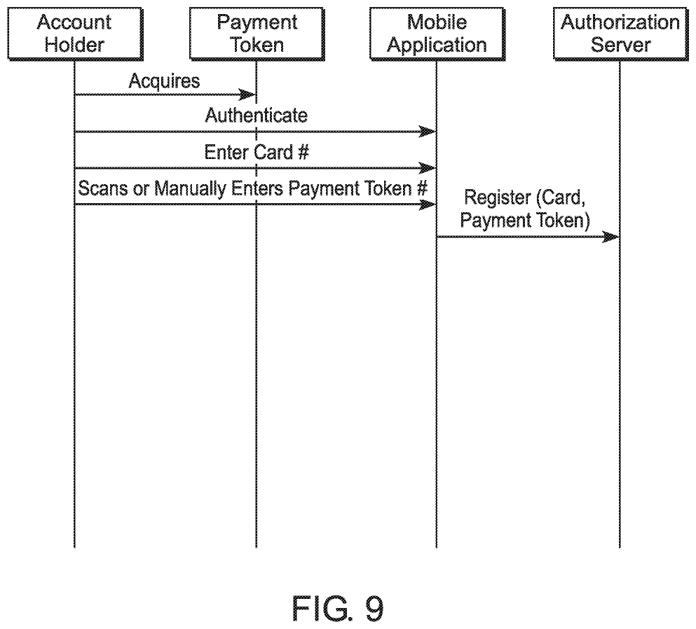

Further to non-limiting embodiments or aspects, FIG. 9 illustrates a possible process flow underlying the operational steps represented in FIG. 8. The flow is among an account holder, a payment application, and an authorization server, beginning with the account holder acquiring the payment token.

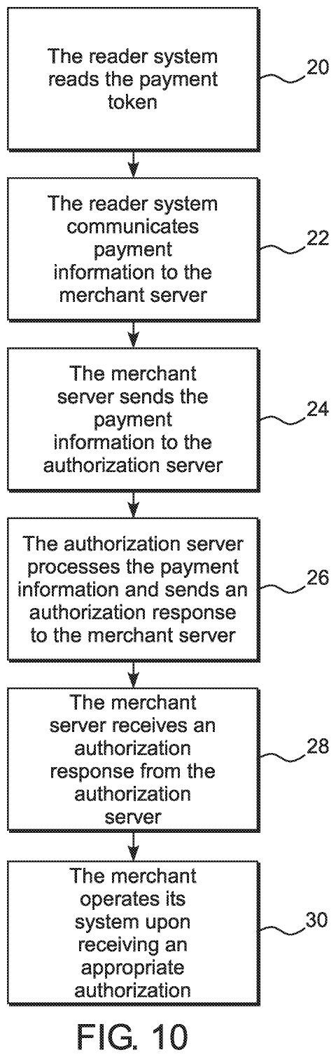

According to non-limiting embodiments or aspects, FIG. 10 describes an operation with which a payment token bound to a payment account may be used to authorize a payment. As expressed, step 20 may initiate a payment with an auxliary payment system reading a payment token. In step 22 the auxliary payment system may then communicate processed information to a merchant's server which, in step 24, may then transmit the information to an authorization server associated with the payment account. In step 26, the authorization server may receive and process the sent information and send an authorization response, which the merchant receives in step 28. If the received response is one which may authorize the payment, the merchant may operate its system in a final step, step 30.

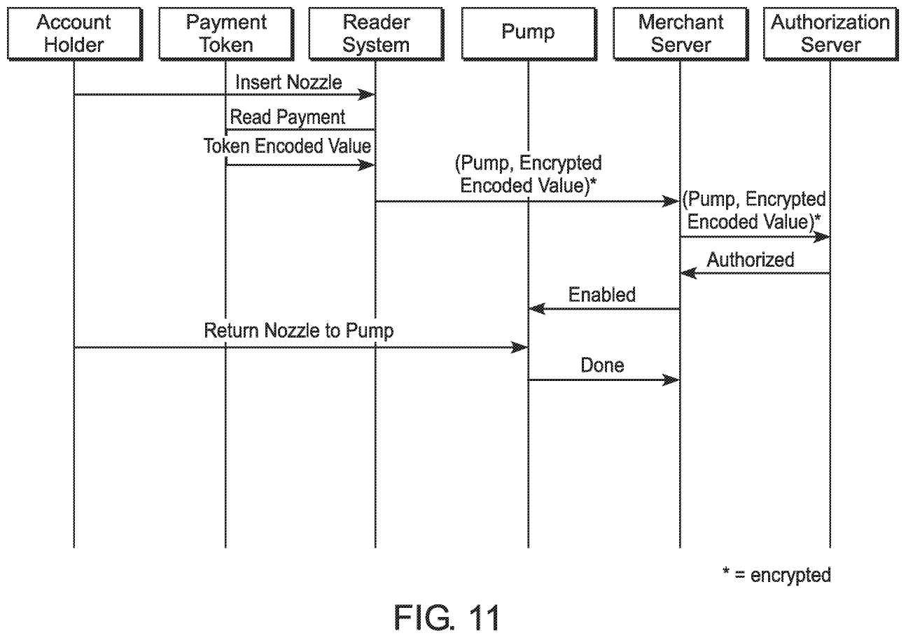

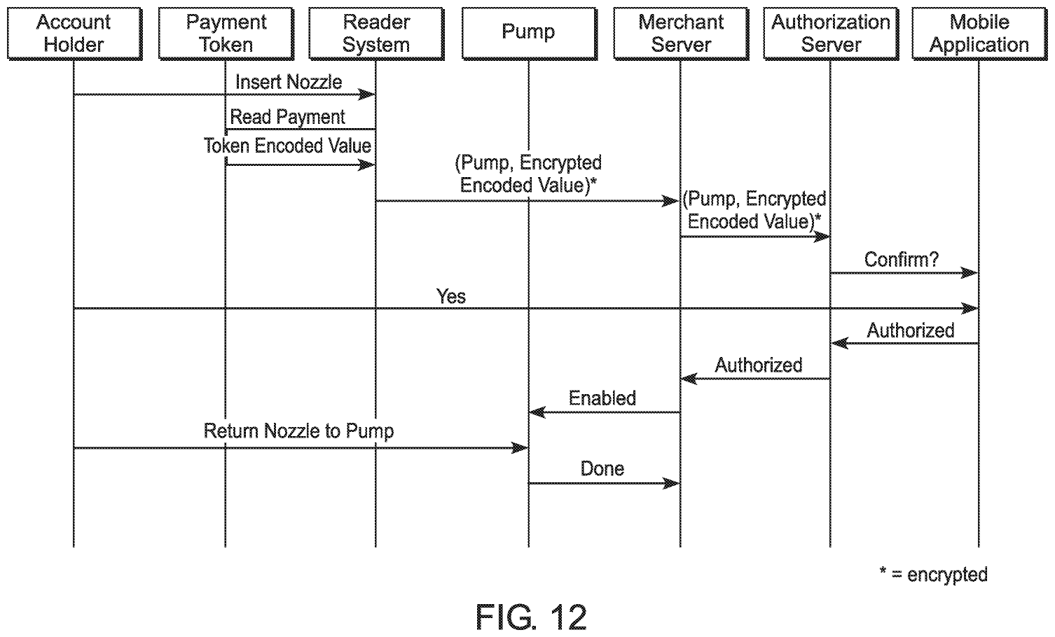

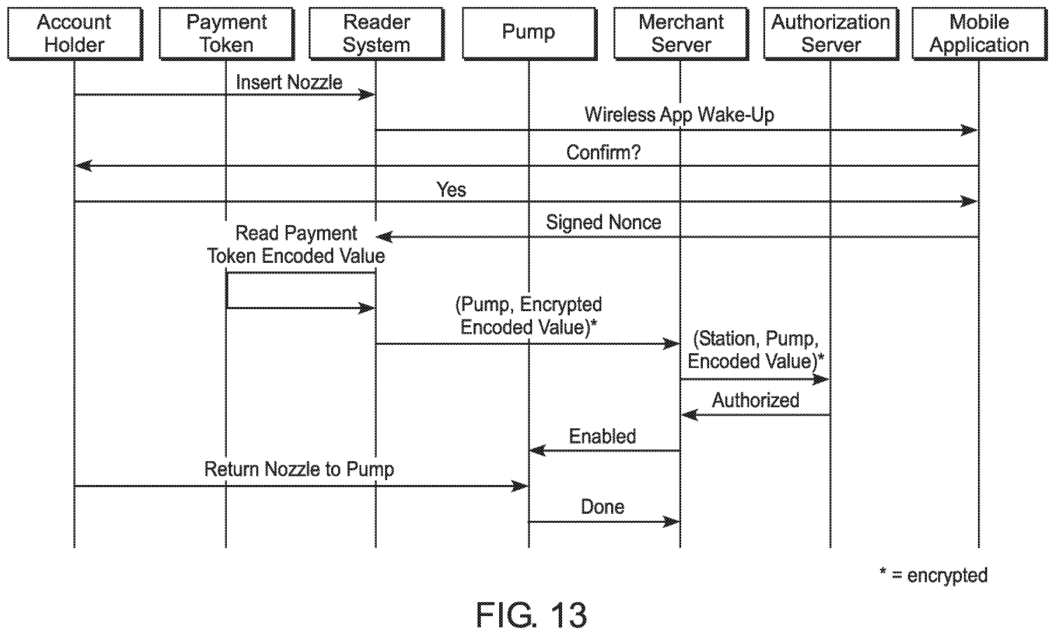

According to non-limiting embodiments or aspects, FIG. 11, FIG. 12, and FIG. 13 depict representative alternative exemplary process flows illustrated in Fig.5, FIG. 6, and FIG. 7 and by the type of operation characterized in FIG. 10. FIG. 11 illustrates a reading of a payment token when a gas pump's nozzle is inserted into a gas tank, a capturing of the payment token by the auxliary payment system, a communication of the payment token's encrypted payment account data to a merchant server, a transmission of merchant and payment token information from the merchant server to an authorization server, in response to which the authorization server sends an authorization message to the gas pump being used, thereby initiating the operation of the pump. The transaction may end when the gas pump nozzle is replaced on the pump. FIG. 12 illustrates adding steps wherein the authorization server sends to and receives messages from the account holder's device to confirm that a payment transaction may be being conducted by the account holder before the payment may be authorized. Finally, FIG. 13 incorporates steps illustrating the gas auxiliary payment system making a payment application on an account holder's device, the account holder confirming the transaction, in response to which a nonce may be assigned to be used when encrypting payment token(s) payment account data read by a payment system.

Although non-limiting embodiments have been described in detail for the purpose of illustration based on what is currently considered to be the most practical and preferred embodiments or aspects, it is to be understood that such detail is solely for that purpose and that the disclosure not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment or aspect.

1. A payment system apparatus that integrates with a merchant's non-payment equipment, comprising:
at least one transceiver system arranged on or integrated with the merchant's non-payment equipment, the at least one transceiver system configured to read encoded account data stored on at least one payment token arranged on a surface of a structure that: opens or closes, raises and lowers, or any combination thereof; and
an interface in communication with the at least one transceiver system, the interface configured to communicate the encoded account data to payment equipment associated with the at least one merchant, the payment equipment.

2. The payment system apparatus of claim 1, further comprising:
at least one power system;
at least one camera system;
at least one RFID active receiver;
at least one communication system; and
a computer system programmed to receive, process and encrypt at least one payment token's payment account data, at least one communication signal comprising the payment token's payment account data, or any combination thereof, and communicate the result to at least one merchant's payment equipment which may comprise a point-of-sale, a merchant back-end server, a payment processor server, a bank server, or any combination thereof, and which may serve as an authentication server, an authorization server, or any combination thereof.

3. The payment system apparatus of claim 1, wherein the at least one payment system apparatus:
integrates with at least one merchant's non-payment equipment;
reads payment account data from at the at least one payment token; and
communicates the read payment account data to the at least one merchant's payment equipment located remotely from the merchant's non-payment equipment.

4. The payment system apparatus of claim 1, wherein the at least one merchant's payment equipment comprises a server, a payment processor server, a bank server, or any combination thereof.

5. The payment system apparatus of claim 1, wherein the at least one non-payment apparatus comprises a gas pump handle or nozzle.

6. The payment system apparatus of claim 1, wherein the at least one payment token attaches to a surface of a structure that opens and closes, or raises and lowers, or any combination thereof.

7. The payment system apparatus of claim 2, wherein the at least one power system comprises a solar panel powering a battery.

8. The payment system apparatus of claim 2, wherein the at least one power system comprises a battery.

9. The payment system apparatus of claim 2, wherein the at least one camera system comprises a camera, a lighting source, or any combination thereof.

10. The payment system apparatus of claim 2, wherein the at least one communication system comprises a near-field communication system, a Wi-Fi® system, a Bluetooth® system, or any combination thereof.

11. The payment system apparatus of claim 2, wherein the computer system comprises a single-board computer, a multi-chip processor, a programmed array, a neural net processor, or any combination thereof.

12. The payment system apparatus of claim 2, wherein the at least one payment token comprises a QR code, a bar code, or any combination thereof.

13. The payment system apparatus of claim 2, wherein the at least one communication signal comprises a RFID signal, Wi-Fi® signal, a Bluetooth® signal, or any combination thereof.

14. The payment system apparatus of claim 2, wherein the at least one payment token comprises an RFID tag.

15. The payment system apparatus of claim 2, wherein the at least one payment token comprises a QR code or a bar code.

16. The payment system apparatus of claim 2, wherein the at least one payment token comprises an embossed QR image or an etched QR image.

17. The payment system apparatus of claim 2, wherein the at least one payment token comprises an embossed bar code image or an etched bar code image.

18. The payment system apparatus of claim 1, wherein the at least one payment token is associated with payment account data comprising an arbitrary long alphanumeric value, a credit card number, a debit card number, a biometric, a BIN number, user name, or any combination thereof.

19. A payment system method, comprising:
acquiring a payment token;
authenticating the at least on payment token in at least one payment application;
entering account information for at least one account encoded on the at least one payment token in the at least one payment application;
scanning or manually entering, or any combination thereof, the at least one payment token in the at least one payment application, in response to which the application links the at least one payment token with the account information; and
registering and communicating the linked account information to at least one merchant payment equipment.

20.-22. (canceled)

23. A computer program product for capturing at least one payment token's payment account data from a payment token linked to at least one payment account comprising at least one non-transitory computer-readable medium including one or more instructions that, when executed by at least one computer system, cause the at least one computer system to:
encrypt payment account data of a payment token that links to a payment account and
communicate the payment token's encrypted payment information to the merchant's payment equipment comprising a server, a payment processor server, a bank server, or any combination thereof, any of which may comprise an authentication server, an authorization server, or any combination thereof, in response to which, it receives an authorization response from the authorization server and enables a merchant's non-payment equipment to operate or to receive payment, or any combination thereof, when the payment is authorized.

24.-30. (canceled)
